(19) United States
(12) Patent Application Publication
(10) Pub. No.: US 2026/0299901 A1
(43) Pub. Date: Oct. 1, 2026

(54) CODE IMPROVEMENT SYSTEM

(71) Applicant: TOYOTA JIDOSHA KABUSHIKI KAISHA, Toyota-shi (JP)

(72) Inventors: Yuya MOCHIMARU, Tokyo-to (JP); Suigen KOIDE, Kyoto-shi (JP); Shinsuke YAMAUCHI, Toyota-shi (JP)

(73) Assignee: TOYOTA JIDOSHA KABUSHIKI KAISHA, Toyota-shi (JP)

(21) Appl. No.: 19/572,092

(22) Filed: Mar. 19, 2026

(30) Foreign Application Priority Data
Mar. 26, 2025 (JP) 2025-052356

(51) Int. Cl. G06F 8/35

(52) U.S. Cl. CPC G06F 8/35

(57) ABSTRACT

A code improvement system includes a coder agent and a reviewer agent, both of which are AI agents. An original code used in programming is input into the coder agent, the coder agent corrects the original code to generate a corrected code, the reviewer agent reviews the corrected code generated by the coder agent and outputs a review report, and iterative feedback is executed between the coder agent and the reviewer agent until the quality of the corrected code generated by the coder agent meets a predetermined quality threshold.

### FIELD

The present disclosure relates to a code improvement system.

### BACKGROUND

Patent Literature 1 (Japanese Unexamined Patent Publication (Kokai) No. 2018-84939) describes a technology in which the correction load of source code is reduced.

In the technology described in Patent Literature 1, a generative AI model (large language model) is not used to reduce the correction load of source code. Therefore, there is a risk that the correction load may not be sufficiently reduced.

For example, in programming of an embedded system in vehicle development, coding in the C/C++ language is the mainstream, and it is required to comply with in-vehicle coding guideline, such as the Motor Industry Software Reliability Association (MISRA) standards, for quality assurance. For example, MISRA provides detailed guidelines for improving the security, portability, and reliability of codes in development of embedded software in the automotive industry in particular.

Even if a generative AI model (large language model) is used for code correction, when unidirectional code correction is performed by a single generative AI model (large language model), there is a risk that the quality of the generated corrected code and detailed explanations of the review may be insufficient. A technology which can improve the quality of the corrected code, present a report of the review of the corrected code, and present the evaluation results of the corrected code and review report, is desired.

### SUMMARY

In view of the above, an object of the present disclosure is to provide a code improvement system that can improve the quality of the corrected code and present a report of the review of the corrected code.
(1) One aspect of the present disclosure is a code improvement system including a coder agent and a reviewer agent, both of which are AI agents, wherein an original code used in programming is input into the coder agent, the coder agent is configured to correct the original code to generate a corrected code, the reviewer agent is configured to review the corrected code generated by the coder agent and output a review report, and iterative feedback is executed between the coder agent and the reviewer agent until the quality of the corrected code generated by the coder agent meets a predetermined quality threshold.
(2) In the code improvement system according to the aspect (1), the code improvement system may include an evaluator agent which is an AI agent, the evaluator agent may calculate evaluation information indicating evaluation results of the corrected code generated by the coder agent and the review report output by the reviewer agent, and three-way iterative feedback may be executed among the coder agent, the reviewer agent, and the evaluator agent until the quality of the corrected code generated by the coder agent meets the predetermined quality threshold.
(3) In the code improvement system according to the aspect (1) or (2), the original code and an error report indicating an error, which does not comply with a coding guideline and is included in the original code, may be input into the coder agent, the coder agent may be configured to generate the corrected code which is a code corrected to comply with the coding guideline, and the reviewer agent may be configured to analyze a reason for correction which is a reason why the original code was corrected to the corrected code and a compliance status with the coding guideline which was applied to the correction from the original code to the corrected code, for each correction point of the corrected code generated by the coder agent, and output the analysis results as the review report.
(4) In the code improvement system according to any one of the aspects (1) to (3), when the results of the review report output by the reviewer agent indicate that the quality of the corrected code does not meet the predetermined quality threshold, the coder agent may be configured to automatically perform a re-correction of the corrected code, the reviewer agent may be configured to perform a re-review which is a review of the corrected code which was re-corrected by the coder agent, and iterative feedback may be executed between the coder agent and the reviewer agent until the quality of the corrected code generated by the coder agent meets the predetermined quality threshold.
(5) In the code improvement system according to any one of the aspects (1) to (4), the evaluator agent may be configured to: evaluate the corrected code generated by the coder agent and the review report output by the reviewer agent; calculate the evaluation information including at least a reason for correction which is a reason why the original code was corrected to the corrected code and a confidence level; determine whether the re-correction of the corrected code by the coder agent and/or the re-review by the reviewer agent is necessary, as needed; and notify at least one of a user of the code improvement system, the coder agent, and the reviewer agent of the determination result of whether the re-correction of the corrected code by the coder agent and/or the re-review by the reviewer agent is necessary.

According to the present disclosure, the quality of the corrected code can be improved and a report of the review of the corrected code can be presented.

### BRIEF DESCRIPTION OF DRAWINGS

FIG. 1 is a view showing an example of a code improvement system 1 of a first embodiment.

FIG. 2 is a view for explaining an example of a corrected code and the like output by a coder agent 11.

FIG. 3 is a view for explaining an example of a corrected code and the like output by a coder agent 11.

FIG. 4 is a view for explaining an example of a corrected line of the corrected code (a line corrected from the original code).

FIG. 5 is a view for explaining an example of a corrected code including a reason for correction and a corrected line, and the like.

### DESCRIPTION OF EMBODIMENTS

The embodiments of the code improvement system of the present disclosure will be described below with reference to the drawings.

### First Embodiment

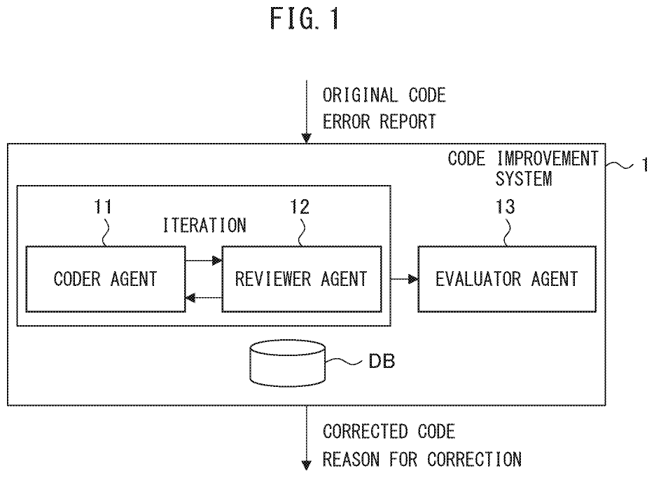

FIG. 1 is a view showing an example of a code improvement system 1 of a first embodiment. In the example shown in FIG. 1, the code improvement system 1 includes a coder agent 11, a reviewer agent 12, an evaluator agent 13, and a database DB. In another example, the evaluator agent 13 and/or the database DB may be provided outside the code improvement system 1.

In the example shown in FIG. 1, the coder agent 11 is an AI (artificial intelligence) agent. An original code (e.g., C, C++, Rust, etc.) used in programming and an error (violation) report indicating an error which does not comply with a coding guideline (e.g., coding convention (automotive coding guideline) such as MISRA, AUTOSAR (AUTomotive Open System ARchitecture) or the like, non-automotive coding guideline, etc.) and is included in the original code, are input into the coder agent 11. The error report input into the coder agent 11 is obtained by analyzing the original code using, for example, static analysis tool (e.g., Ccptest, etc.).

The coder agent 11 generates (outputs) a corrected code which is a code corrected to comply with the coding guideline.

Specifically, the coder agent 11 uses a technology of information addition type generation means (RAG (Retrieval-Augmented Generation)) and generates the corrected code while referring to information of the coding guideline and a model answer collection of correction examples created by a code corrector stored in the database DB as external information.

The “information addition type generation means” corresponds to traditional RAG (Retrieval-Augmented Generation) technology and refers to a technology in general for assisting and enhancing generation of a corrected code and the like, by adding external information pre-stored in a database or the like, an external information search result, or information acquired by external API integration or the like to an input to the generative AI model. In other words, any technology for correcting a generated output by adding external information, such as automatic acquisition of external information, integration of contextual information or the like in addition to the RAG technology is assumed to be included in the “information addition type generation means” in the present specification.

“Generative AI model” is not limited to large language model (LLM) as conventionally mentioned and encompasses various generation technologies including non-text modal such as a multimodal model, an image generation model, a voice generation model, and the like. In other words, all generative models (e.g., a large language model, a multimodal model, an image generation model, and the like) having the capability to output a corrected code and the like based on input information are assumed to be included in the “generative AI model” in the present specification.

The corrected code output from the coder agent 11 includes a reason for correction (reason why the original code was corrected to the corrected code) as described later. The provision of the external information from the database DB to the coder agent 11 may be done dynamically (i.e., the latest external information may be stored in the database DB and provided to the coder agent 11). This enables automatic correction that flexibly responds to environmental changes.

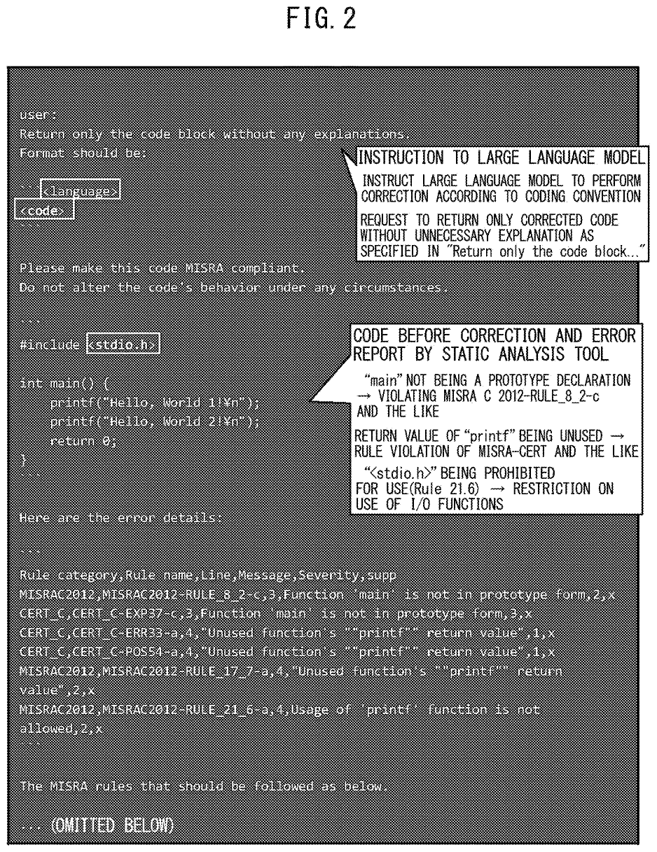

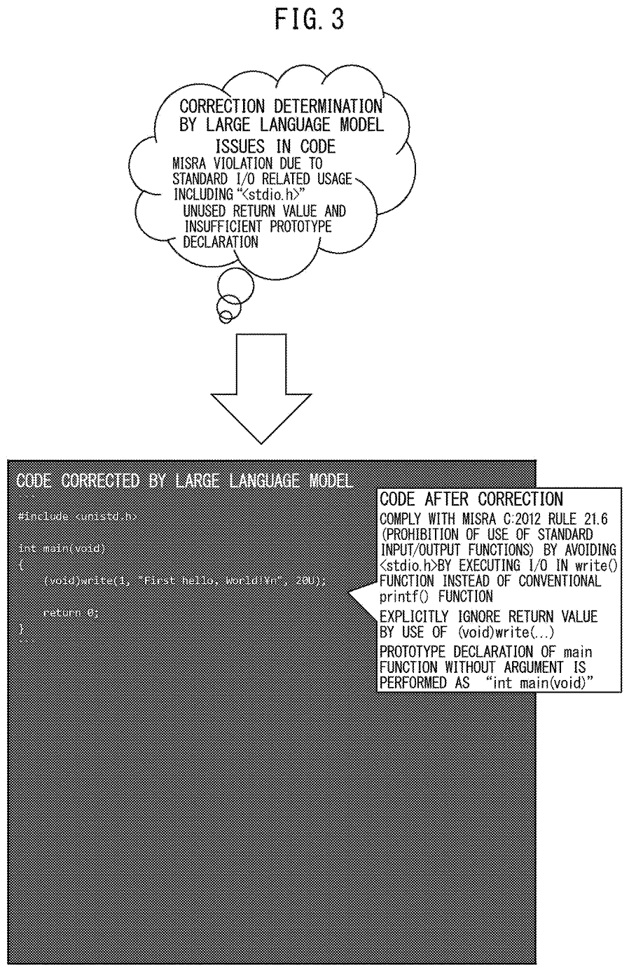

FIG. 2 and FIG. 3 are views for explaining examples of the corrected code output by the coder agent 11. Specifically, FIG. 2 shows an example of the original code before correction by the coder agent 11 (generative AI model (large language model)), and FIG. 3 shows an example of the corrected code which is the code after correction to the original code shown in FIG. 2 is performed by the coder agent 11.

In the example shown in FIG. 2 and FIG. 3, as shown in FIG. 2, the user of the code improvement system 1 instructs the coder agent 11 of the code improvement system 1 to perform the correction according to the coding convention. Specifically, the user of the code improvement system 1 requests the coder agent 11 of the code improvement system 1 to return only the corrected code without unnecessary explanation.

Further, in the examples shown in FIG. 2 and FIG. 3, the error (violation) report (result of analysis of the original code performed by using the static analysis tool or the like) is input into the coder agent 11, as shown in FIG. 2. The error report includes: “main” not being a prototype declaration (violating MISRA C 2012-RULE_8_2-c and the like); return value of “printf” being unused (rule violation of MISRA-CERT and the like); and “<stdio. h>” being prohibited for use (Rule 21.6) (restriction on use of I/O functions).

In the examples shown in FIG. 2 and FIG. 3, the coder agent 11 (generative AI model) determines that MISRA violation due to standard I/O related usage including “<stdio.h>,” unused return value and insufficient prototype declaration are issues in the original code, and corrects the code.

As shown in FIG. 3, the corrected code complies with MISRA C:2012 RULE 21.6 (prohibition of use of standard input/output functions) by avoiding <stdio.h>by executing I/O in write( ) function instead of the conventional printf( ) function. Further, the corrected code explicitly ignores the return value by the use of (void)write( . . . ). Furthermore, in the corrected code, prototype declaration of the main function without argument is performed as “int main(void).”

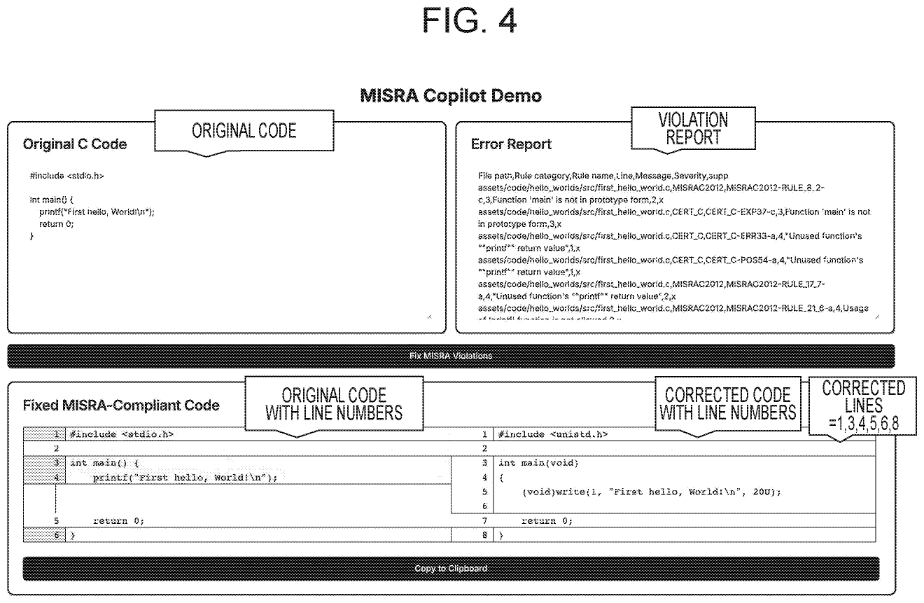

FIG. 4 is a view for explaining an example of the corrected lines (lines in which the correction was made to the original code) included in the corrected code. Specifically, the upper left part of FIG. 4 shows the original code input to the coder agent 11, the upper right part of FIG. 4 shows the violation report (error report) indicating the analysis results of the original code shown in the upper left part of FIG. 4, the lower left part of FIG. 4 shows the original code with line numbers, and the lower right part of FIG. 4 shows the corrected code with line numbers generated by the coder agent 11.

In the example shown in FIG. 4, as can be seen by comparing the original code with line numbers shown in the lower left part of FIG. 4 and the corrected code with line numbers shown in the lower right part of FIG. 4, lines 1, 3, 4, 5, 6, and 8 of the corrected code with line numbers shown in the lower right part of FIG. 4 correspond to the corrected lines.

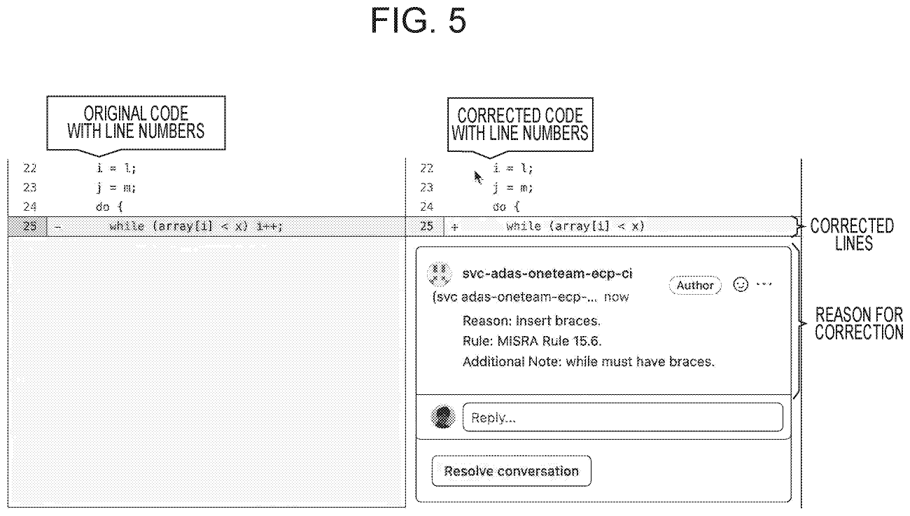

FIG. 5 is a view for explaining an example of the corrected code including the reason for correction and the corrected lines, and the like. Specifically, the left side part of FIG. 5 shows a part of the original code (original code input to the coder agent 11) with line numbers, and the right side part of FIG. 5 shows a part of the corrected code with line numbers including the reason for correction and the corrected lines generated by the coder agent 11.

In the example shown in FIG. 5, as can be seen by comparing the original code with line numbers shown in the left side part of FIG. 5 with the corrected code with line numbers shown in the right side part of FIG. 5, line 25 of the corrected code with line numbers shown in the right side part of FIG. 5 corresponds to the corrected line (line in which the correction was made to the original code).

Also, in the example shown in FIG. 5, as the reason (reason for correction) why the original code shown in the left side part of FIG. 5 was corrected to the corrected code shown in the right side part of FIG. 5, “Reason: Insert braces”, “Rule: MISRA Rule 15.6”, and “Additional Note: while must have braces”, are generated by the coder agent 11.

Therefore, the user of the code improvement system 1 can easily understand the reason why the line 25 of the original code was corrected to line 25 of the corrected code. As a result, the user of the code improvement system 1 can easily determine whether to adopt the corrected code generated by the coder agent 11.

In the example shown in FIG. 1, the reviewer agent 12 is an AI agent. The reviewer agent 12 performs a review (automatic review) (specifically, analysis of the correction point) of the corrected code generated by the coder agent 11 and outputs (generates) a review report.

Specifically, the reviewer agent 12 analyzes (validity of) a reason for correction which is a reason why the original code was corrected to the corrected code and a compliance status with the coding guideline which was applied to the correction from the original code to the corrected code, for each correction point of the corrected code generated by the coder agent 11, and outputs the analysis results (including improvement points, etc.) as the review report. The review report includes the appropriateness of the correction point, the reason for correction, and improvement point.

The reviewer agent 12 proposes a refactoring to the coder agent 11 as needed.

When the results of the review report output by the reviewer agent 12 indicate that the quality of the corrected code generated by the coder agent 11 does not meet a predetermined quality threshold, the coder agent 11 automatically performs re-correction of the corrected code. Specifically, the coder agent 11, based on the review report generated by the reviewer agent 12 (i.e., in response to the proposal of the reviewer agent 12), outputs Note (e.g., comment like “#Reason for correction: Add XX to avoid defects”) indicating the reason for correction or meaning (intent of correction) in the re-corrected code (i.e., adds the Note (comment) in the re-corrected code to clearly indicate the correction details). Therefore, the user of the code improvement system 1 can easily understand the correction details, the readability can be improved.

Also, when the results of the review report output by the reviewer agent 12 indicate that the quality of the corrected code generated by the coder agent 11 does not meet the predetermined quality threshold, the reviewer agent 12 performs a re-review which is a review of the corrected code which was re-corrected by the coder agent 11.

Specifically, until the results of the review report output by the reviewer agent 12 indicate that the quality of the corrected code generated by the coder agent 11 meets the predetermined quality threshold, iterative feedback is executed between the coder agent 11 and the reviewer agent 12, as shown by arrows in FIG. 1. In other words, the coder agent 11 and the reviewer agent 12 exchange results with each other and regenerate and re-review the code as necessary. That is, the corrected code is generated as a result of the interaction between the coder agent 11 and the reviewer agent 12.

The addition of Note (comment) using symbols such as “#” may be performed by the reviewer agent 12.

Also, in the example shown in FIG. 1, the evaluator agent 13 is an AI agent. The evaluator agent 13 comprehensively evaluates the corrected code generated by the coder agent 11 and the review report output by the reviewer agent 12, and calculates (generates) evaluation information indicating the evaluation results. The evaluation information includes at least the aforementioned reason for correction (reason why the original code was corrected to the corrected code) and the confidence level. Risk assessment may also be included in the evaluation information. The evaluation information may be presented as a comment on GitHub. By providing the reason for correction and the confidence level, in addition to improving the reliability of the final code (corrected code), points that need to be re-corrected can be clarified, and development time and cost can be reduced.

Additionally, the evaluator agent 13 determines whether the re-correction of the corrected code by the coder agent 11 and/or the re-review by the reviewer agent 12 is necessary, as needed. Furthermore, the evaluator agent 13 notifies at least one of the user of the code improvement system 1, the coder agent 11, and the reviewer agent 12 of the determination result of whether the re-correction of the corrected code by the coder agent 11 and/or the re-review by the reviewer agent is necessary. In other words, an indicator for determining whether the re-correction of the code (correction of the corrected code) is necessary is provided to the coder agent 11, reviewer agent 12, and the like.

The evaluator agent 13 may present the calculated (generated) evaluation information as comments on platforms such as GitHub. Additionally, the evaluator agent 13 may calculate the final quality score and provide indicators for determining the necessity of additional corrections to, for example, the coder agent 11.

Furthermore, in the example shown in FIG. 1, three-way iterative feedback is executed among the coder agent 11, the reviewer agent 12, and the evaluator agent 13 (in other words, code correction, review, and evaluation are repeated) until the quality of the corrected code generated by the coder agent 11 meets the predetermined quality threshold (e.g., “the error occurrence rate becomes less than 50%, or the evaluation score exceeds a predetermined value”). In other words, the coder agent 11, the reviewer agent 12, and the evaluator agent 13 collaborate as a trio. Specifically, as shown by the arrows in FIG. 1, at each stage of the iterative feedback between the coder agent 11 and the reviewer agent 12, the evaluator agent 13 evaluates the code and review content and instructs and supports them to continue the process until the final code (corrected code) meets the predetermined quality threshold (e.g., the error occurrence rate becomes less than a predetermined value, or the quantitative score exceeds a predetermined value). The maximum number of iterations for iterative feedback may be set by the user of the code improvement system 1.

In the example shown in FIG. 1, the quality of the corrected code generated by the coder agent 11 can be improved (i.e., correction errors can be reduced), and the review report of the corrected code generated (output) by the reviewer agent 12 can be presented to the user of the code improvement system 1, etc. The evaluation results of the corrected code and review report by the evaluator agent 13 can be presented to the user of the code improvement system 1, etc. (i.e., the user of the code improvement system 1, etc. can confirm them via the user interface and adopt the final code (corrected code)).

In other words, the code improvement system 1 of the first embodiment is an iterative collaboration type code review, refactoring, and evaluation system among multiple AI agents, enabling iterative processing of code generation, review, and evaluation through collaboration among multiple AI agents. As a result, the quality and readability of code corrections can be improved.

As described above, in the code improvement system 1 of the first embodiment, the coder agent 11, reviewer agent 12, and evaluator agent 13 collaborate, and the three-way iterative feedback is executed among the coder agent 11, reviewer agent 12, and evaluator agent 13. Therefore, the quality, readability, and safety of the generated code can be improved significantly.

Additionally, since the reviewer agent 12 or the like adds Note (comment), the intent of each correction becomes clear. Therefore, the user of the code improvement system 1 can easily understand the correction details. Furthermore, since the evaluator agent 13 presents the reason for correction and the confidence level, quick determination of the necessity for further code correction is possible, the reliability of the final code (corrected code) can be improved. As a result, it is possible to achieve a reduction in development man-hours and an improvement in the safety and maintainability of the product.

In the code improvement system 1 of the first embodiment, the data generated in each process of the coder agent 11, reviewer agent 12, and evaluator agent 13 is recorded and stored as artifacts in the database DB, which can be utilized for future quality management and improvement of the code improvement system 1.

### Second Embodiment

The code improvement system 1 of a second embodiment is configured similarly to the code improvement system 1 of the first embodiment described above, except for the points described later.

The code improvement system 1 of the first embodiment described above is implemented on a computer (e.g., a server computer) other than the computer used by the user of the code improvement system 1. Therefore, multiple users and engineers can access the computer on which the code improvement system 1 is implemented via a network, etc., and use the code improvement system 1. In other words, correction process, review process, etc., can be performed simultaneously in a shared environment. The user of the code improvement system 1 can adopt the corrected code or give further correction instructions based on Note (comment) displayed on the user interface of the computer used by the user of the code improvement system 1. When manual intervention by the user of the code improvement system 1 is necessary, correction instructions through the user interface are also incorporated into the code improvement system 1 and reflected in subsequent automatic corrections. The code improvement system 1 of the first embodiment may have a learning function that allows multiple users to provide feedback simultaneously via a network, improving the accuracy of subsequent automatic corrections through aggregated data.

On the other hand, the code improvement system 1 of the second embodiment is implemented on a computer (edge computer) used by the user of the code improvement system 1.

As described above, the embodiments of the code improvement system of the present disclosure have been explained with reference to the drawings, but the code improvement system of the present disclosure is not limited to the embodiments described above and can be appropriately modified without departing from the spirit of the present disclosure. The configurations of each example of the embodiments described above may be combined as appropriate. In each example of the embodiments described above, the process performed in the code improvement system 1 has been described as software process performed by executing a program, but the process performed in the code improvement system 1 may also be the process performed by hardware. Alternatively, the process performed in the code improvement system 1 may be the process that combines both software and hardware. Additionally, the program stored in the memory of the code improvement system 1 (program for realizing the functions of the processor of the code improvement system 1) may be recorded and provided, distributed, etc., on computer-readable recording media such as semiconductor memory, magnetic recording media, optical recording media, etc.

What is claimed is:

1. A code improvement system comprising a coder agent and a reviewer agent, both of which are AI agents,
wherein an original code used in programming is input into the coder agent,
the coder agent is configured to correct the original code to generate a corrected code,
the reviewer agent is configured to review the corrected code generated by the coder agent and output a review report, and
iterative feedback is executed between the coder agent and the reviewer agent until the quality of the corrected code generated by the coder agent meets a predetermined quality threshold.

2. The code improvement system according to claim 1, comprising an evaluator agent which is an AI agent,
wherein the evaluator agent is configured to calculate evaluation information indicating evaluation results of the corrected code generated by the coder agent and the review report output by the reviewer agent, and
three-way iterative feedback is executed among the coder agent, the reviewer agent, and the evaluator agent until the quality of the corrected code generated by the coder agent meets the predetermined quality threshold.

3. The code improvement system according to claim 1, wherein the original code and an error report indicating an error, which does not comply with a coding guideline and is included in the original code, are input into the coder agent,
the coder agent is configured to generate the corrected code which is a code corrected to comply with the coding guideline, and
the reviewer agent is configured to analyze a reason for correction which is a reason why the original code was corrected to the corrected code and a compliance status with the coding guideline which was applied to the correction from the original code to the corrected code, for each correction point of the corrected code generated by the coder agent, and output the analysis results as the review report.

4. The code improvement system according to claim 1, wherein when the results of the review report output by the reviewer agent indicate that the quality of the corrected code does not meet the predetermined quality threshold, the coder agent is configured to automatically perform a re-correction of the corrected code, the reviewer agent is configured to perform a re-review which is a review of the corrected code which was re-corrected by the coder agent, and
iterative feedback is executed between the coder agent and the reviewer agent until the quality of the corrected code generated by the coder agent meets the predetermined quality threshold.

5. The code improvement system according to claim 2, wherein the evaluator agent is configured to:
evaluate the corrected code generated by the coder agent and the review report output by the reviewer agent;
calculate the evaluation information including at least a reason for correction which is a reason why the original code was corrected to the corrected code and a confidence level;
determine whether the re-correction of the corrected code by the coder agent and/or the re-review by the reviewer agent is necessary, as needed; and
notify at least one of a user of the code improvement system, the coder agent, and the reviewer agent of the determination result of whether the re-correction of the corrected code by the coder agent and/or the re-review by the reviewer agent is necessary.
